(19) United States
(12) Patent Application Publication
(10) Pub. No.: US 2011/0133431 A1
(43) Pub. Date: Jun. 9, 2011

(54) One-stop trailer hitch

(76) Inventor: Theoda Dunn, Lexington, TN (US)

(21) Appl. No.: 12/655,950

(22) Filed: Nov. 5, 2010

Related U.S. Application Data
(60) Provisional application No. 61/143,723, filed on Jan. 9, 2009.

(51) Int. Cl. B60D 1/36; B60D 1/06; B60D 1/52

(52) U.S. Cl. 280/477

(57) ABSTRACT

A trailer receiver hitch (shank and ball) style is provided that enables safer hook-ups to a trailer. The hitch includes a shank and ball assembly that is combined with a v-shaped guard that protects the rear of the vehicle; tailgate, bumper, license plate, etc. from collision damage from the trailer tongue as the user backs the vehicle towards the trailer for hook-up.

The v-shaped guard creates a guide for the trailer tongue to assist in centering the tongue over the hitch ball. As the vehicle backs to the tongue the design will move the tongue in the center directly over the hitch ball.

Each part of this hitch is formed from cold rolled steel to form one complete assembly.

### FIELD OF THE INVENTION

This invention relates to receiver hitches for automobiles and trucks that are designed to pull a trailer in tow.

### BACKGROUND OF THE INVENTION

We have developed a hitch product that makes hooking up to your trailer safer and easier. This product offers innovation in design with its wing shaped shield/guide and presents a viable solution to safety and ease of hook-up to any trailer. Damage created by backing into your trailer tongue to your vehicle is a major consideration of this invention. Also, the wing shaped guide helps to line up your trailer hitch over the hitch ball on your vehicle.

### SUMMARY OF THE INVENTION

In accordance with the invention, a trailer receiver hitch is provided which enables the user to perform the task of hooking up to a trailer with a vehicle safer and simpler. The metal wing shaped plate guides the trailer tongue over the hitch ball while protecting the same vehicle from the collision with the trailer tongue and the rear of the vehicle because of inaccurate judgment on the drivers' part.

### DESCRIPTION OF DRAWINGS

The following drawings represent this trailer hitch invention.

FIG. 1 is an overhead view of the D-Wyng Hitch

FIG. 2 is a side elevation view of the D-Wyng Hitch (from the side of the vehicle)

FIG. 3 is a front elevation view of the D-Wyng Hitch (from the rear of the vehicle)

### DESCRIPTION OF THE PREFERRED EMBODIMENTS

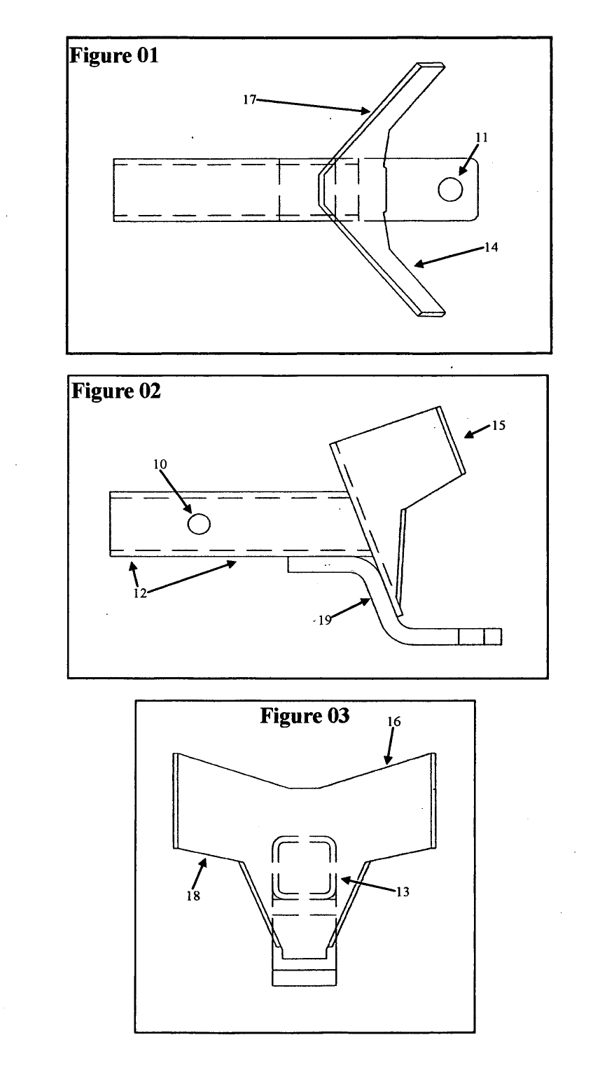

Referring to the drawings, a receiver hitch, generally denoted in FIG. 1, FIG. 2, and FIG. 3, is provided to attach a trailer to a vehicle for towing. The hitch is comprised of features that will: 1) Safely secure the hitch into your receiver (FIG. 2-10) using the ¾″ hole provided for the security pin to pass through. 2) Safely and securely attach a trailer hitch ball (FIG. 1-11) to the hitch through the provided drilled opening. 3) Fit in to a standard 2″×2″ receiver type hitch (FIG. 2-12) and (FIG. 3-13)

The metal wing depicted in the drawings (FIG. 1-14) (FIG. 2-15) (FIG. 3-16) generally resembles a v-shaped metal guide that will assist in guiding the trailer tongue over the hitch ball. The secondary purpose is to provide some protection the rear of the vehicle as you back towards the trailer tongue. The metal wing on the invention is comprised of ⅜″ cold rolled steel, bent in the center to create a v-shaped guide for the trailer tongue (FIG. 1-17) (FIG. 3-18).

In accordance with the invention the lower portion of the hitch frame is ½″ cold rolled steel construction (FIG. 2-19) with a 13/16″ hole drilled (FIG. 1-11) for the insertion and attachment of the trailer hitch ball.

1. A receiver type trailer hitch mechanism for use with a vehicle for towing. Said hitch mechanism comprising a receiver attachable to the vehicle, said receiver having an open end and a draw bar slidably insertable into, retainable in, and removable from the open end of the receiver. Hitch mechanism comprises; a square shaft that is insertable in the receiver on the vehicle with a hole drilled for a locking pin once inserted. Attached to said square insertion shaft is a rigidly connected ball mount draw bar. Between said shaft and said draw bar is a V-shaped, vertically mounted guard. Said guard is securely and rigidly attached to both square shaft and draw bar to comprise a complete hitch mechanism.
